(19) United States
(12) Patent Application Publication
(10) Pub. No.: US 2007/0256538 A1
(43) Pub. Date: Nov. 8, 2007

(54) Method and apparatus for counter-weighting a bass drum

(76) Inventor: Michael Brian Parra, Oxnard, CA (US)

Correspondence Address: Michael Brian Parra, 1450 Bayview Drive, Oxnard, CA, 93035, US

(21) Appl. No.: 11/382,244

(22) Filed: May 8, 2006

(51) Int. Cl. G10D 13/02

(52) U.S. Cl. 84/422.1

(57) ABSTRACT

This invention is a new and useful method and apparatus for counter-weighting a bass drum to prevent slippage while in use on hard, slick floors in a traditional rock or jazz-style percussion arrangement. This method and apparatus utilizes the weight of a percussion player sitting on his or her percussion stool or chair as a counter-weight to keep the bass drum from slipping forward as it is played by connecting the forward spurs on the front of the bass drum to the leg or center pole of a drum stool via an adjustable guy-strap system radiating from the center pole or leg of the stool in an arrangement designed with adjustments and hardware for ease of use.

### REFERENCES CITED

US Patent Documents

| | | |
|---|---|---|
| 3,710,670 | 1973 | Winkler |
| 4,126,075 | 1977 | Kabushiki |
| 4,334,612 | 1980 | Beato |
| 4,441,398 | 1982 | Baker |
| 5,677,502 | 1993 | Ladio |
| 5,994,634 | 1997 | Cady |
| 6,794,565 | 2004 | Green |

### BACKGROUND OF THE INVENTION

Bass drum slippage while in use on hard, slick floors such as wood, concrete, tile, etc. in a traditional rock or jazz-style percussion arrangement is a persistent functional problem widely known to percussionists and other musicians. This is due to the bass drum, traditionally set up on the floor with the drum face toward the musician, being repeatedly struck with a beater or mallet (herein called mallet) attached to a foot pedal apparatus that transfers the downward motion of the drummer's foot into a forward swinging motion of the mallet that strikes the bass drum. The bass drum is typically a large drum with forward spurs or legs (herein called spurs) that engage the floor. On hard, slick floors such as wood, tile or concrete, etc., the inert mass of the drum and its friction against the floor is less than the momentum that the velocity of the mallet produces as it strikes the drum. What results is a small forward movement of the drum away from the drummer that compounds over repeated strikes in a noticeable slippage or creep that makes confident, consistent playing difficult.

Ideally, where the bass drum is set up is covered with thick carpet. The carpet engages the drum spurs sufficiently and with enough friction to prevent the drum from moving forward. However the reality for drummers who travel or perform in many venues is that thick carpet is a luxury and not the norm. Often times a drummer will find that where he practices or is hired to perform is not intended as a music venue and he has to improvise with various remedies that compensate for the functional problem as described above. Many drummers have simply accepted that toting around a large rug as part of their percussion set up, placing a large object in front of the drum or continually reaching down mid song to pull the bass drum back toward them are the only remedies to this problem. Some drummers are even willing to compromise their music by tenderly playing the bass drum so it will slip less on hard surface floors.

Not as a drummer, but as a music promoter, I encountered this problem as I hired drummers to perform in various venues and was often charged to locate a rug, carpet or some other suitable high friction surface or weighty object to be placed in front of the drum to address the problem of bass drum slippage. I conceived of a very simple, new and useful method and apparatus that would effectively address this problem and I was surprised to find that no one had ever conceived, fabricated or sold a product that used this method before. After an extensive questioning of drummers, music merchants, percussion manufacturers and searching on the internet, I resolved to patent this idea myself having conceived of it as a very simple, effective yet absent solution to a persistent functional problem ubiquitous to percussionists.

The most relevant prior art is contained in U.S. Pat. No. 3,710,670, issued to Winkler in 1973 which connected the seat and drum via a ridged bar system that was facilitated by the use of a specific seat and made the use of bolts that needed to be fastened and unfastened during each use and attached to the drum at the drum keys, which is not conducive to practical use as the drum keys are used in the delicate tuning of the drum which affects the sound and should not be subject to the jarring and tension that this use would inflict. Various other methods including large rugs with lips or blocks attached to the end or interconnecting straps that connected the bass drum to other parts of the percussion set up.

### BRIEF SUMMARY OF THE INVENTION

This invention is a new and useful method and apparatus for counter-weighting a bass drum to prevent slippage while in use on hard, slick floors in a traditional rock or jazz-style percussion arrangement. This method and apparatus utilizes the weight of a percussion player sitting on his or her percussion stool or chair (herein called stool) as a counter-weight to keep the bass drum from slipping forward as it is played by connecting the forward spurs on the front of the bass drum to the leg or center pole of a drum stool via an adjustable guy-strap system radiating from the center pole or leg of the stool in an arrangement designed with adjustments and hardware for ease of use.

### DESCRIPTION OF THE SEVERAL VIEWS OF THE DRAWINGS

FIG. 1

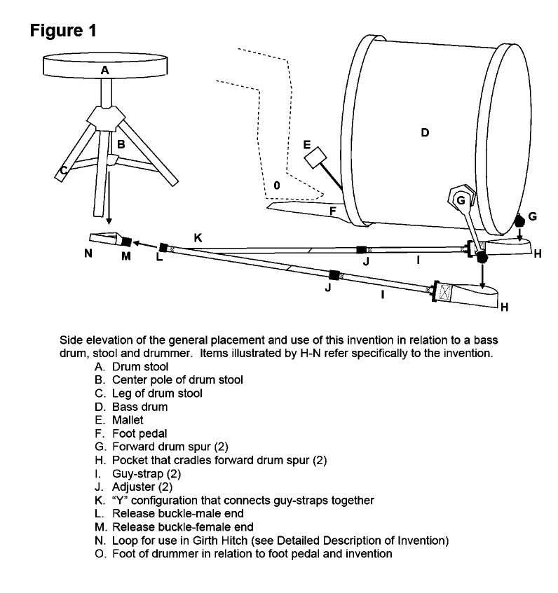

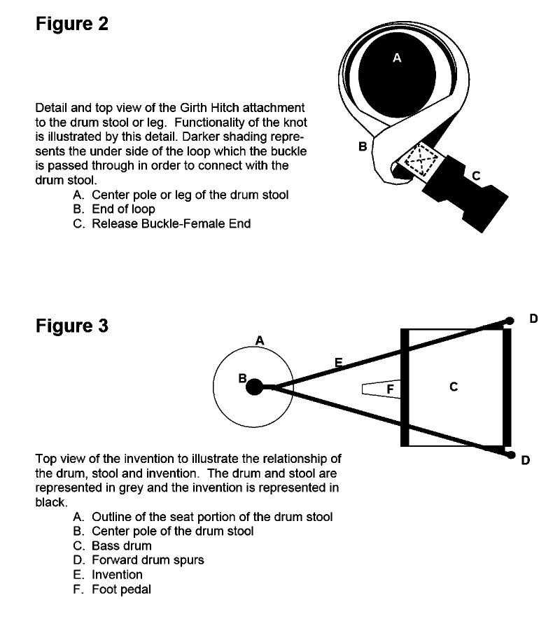

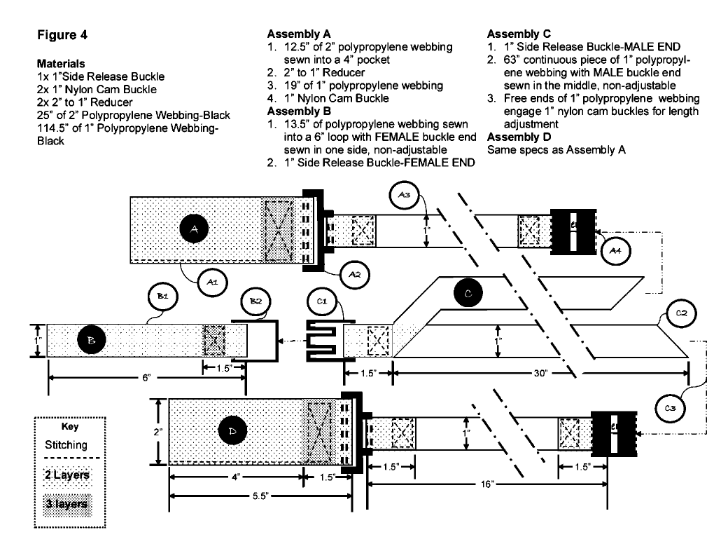

Side elevation of the general placement and use of this invention in relation to a bass drum, stool and drummer. Items illustrated by H-N refer specifically to the invention.
A. Drum stool
B. Center pole of drum stool
C. Leg of drum stool
D. Bass drum
E. Mallet
F. Foot pedal
G. Forward drum spur (2)
H. Pocket that cradles forward drum spur (2)
I. Guy-strap (2)
J. Adjuster (2)
K. “Y” configuration that connects guy-straps together
L. Release buckle-male end
M. Release buckle-female end
N. Loop for use in Girth Hitch (see Detailed Description of Invention)
O. Foot of drummer in relation to foot pedal and invention

FIG. 2

Detail and top view of the Girth Hitch attachment to the drum stool or leg. Functionality of the knot is illustrated by this detail. Darker shading represents the under side of the loop which the buckle is passed through in order to connect with the drum stool.
A. Center pole or leg of the drum stool
B. End of loop
C. Release Buckle-Female End

FIG. 3

Top view of the invention to illustrate the relationship of the drum, stool and invention. The drum and stool are represented in grey and the invention is represented in black.
A. Outline of the seat portion of the drum stool
B. Center pole of the drum stool
C. Bass drum
D. Forward spurs or leg
E. Invention
F. Foot pedal

FIG. 4

Industrial specifications for building this invention as embodied by polypropylene straps, nylon adjusters, reducers and release buckles and a set of dimensions compatible with a typical percussion arrangement. This illustration is one design example of manifesting this method and apparatus and changes to this specific design in terms of material, dimensions and methods for engaging the drum spurs and drum chair shall not constitute a new invention.

### DETAILED DESCRIPTION OF THE INVENTION

This method and apparatus invokes the use of the physical principle of inertia which provides that the mass of the drummer's body, subject to gravity and friction in its relative position to the ground, being inert, will be greater than the forward momentum of the striking mallet as the force of the strike is subject to certain common proportional relations between the capacity of a drummer leg strength in relation to his own body mass. This force is defused over the entire mass of the drum and into the air producing a sound and is also subject to gravity and friction to its relative position to the ground. Only a small portion of the actual force exerted in the striking of the drum pedal will be transformed into momentum which will impel the drum to move forward. When counter-weighted with the actual weight of the body and seat subject to gravity and friction in its relative position to the ground, the forward momentum of the drum is transformed into tension via its engagement with pockets attached to guy-straps which connect the forward drum spurs to the drum stool which is anchored in place by the greater inert mass of the drummer's body. At the point of the drummer's foot, any forward motion that engages the drum pedal is canceled by an equal and opposite motion of the pivot of the heel, ankle, knee and pelvis which engage the stool and rely on gravity and friction in its relative position to the ground to maintain its location. Thus any forward motion of the drum in neutralized by its relative position and connection with the drummer's stool.

The apparatus as described herein illustrates an embodiment of this method by connecting the forward drum spurs to the drum stool by cradling the ends of the spurs in pockets or some other suitable attachment designed to secure the drum from moving forward. These pockets connect to adjustable guy-straps made of any lightweight, durable material such as nylon, polypropylene, leather, canvas, plastic or any other material designed with the tensile strength and flexibility to maintain composition and usefulness under conditions implied in a use consistent with the circumstances described above.

Two of these straps, one connected to each pocket which in turn cradles each drum strut, connect in a “Y” configuration at a point between the drummer's foot in relation to the drum pedal and the drum stool, consistent with ease of use. The strap assembly at the bottom of the “Y” configuration connects with the drum stool with the use of a durable connection method capable of repeated engagement and disengagement without requiring any specialized equipment or features to be installed on the drum stool, embodied here as knot known commonly as a Lark's Head or Girth Hitch (herein called Girth Hitch), familiar in use and application to most people and evident in use by illustration only, but may be manifested as any securing knot, Velcro, lanyard, loop, latch, lock or other securing method.

Between the Girth Hitch and the “Y” connection of the two guy-straps there shall be a center release or side release buckle made of plastic, nylon, metal or any other material designed with the tensile strength and functionality to maintain composition and usefulness under conditions implied in a use consistent with the circumstances described above installed inline with the strap to allow the drummer to release his seat from the rest of the invention while the Girth Hitch remains fastened to the center pole or leg of the drum stool which will facilitate ease of use and quick set up and break down and may remain attached to the drum stool during storage and transportation while not in use. This description constitutes a convenient feature of the invention and its absence shall not constitute a new invention.

For the purpose of accessible adjustment prior to and during play, buckles or adjusters made of plastic, nylon, metal or any other material designed with the tensile strength and functionality to maintain composition and usefulness under conditions implied in a use consistent with the circumstances described above shall be placed in the line of each of the two guy-straps so they connect with the pockets that engage the drum spurs but are far enough along the strap toward the drum stool that they clear the rear edge of the drum when it is placed on top the invention according to its use. This description constitutes a convenient feature of the invention and its absence shall not constitute a new invention.

This invention stands apart from other inventions seeking to address the same problem in terms of its adjustability, flexibility, ease of use, time required to set up and break down and its universal application to many drum and stool styles and percussion configurations as well as its relative size and transportability within the expectations of drummers toward useful and convenient percussion accessories.

What is claimed is:

1. A method for counter-weighting a bass drum invoking the physical principles of inertia by connecting the forward spurs of the bass drum by a secure cradle or pocket via an adjustable guy-strap system to the center pole or leg of a drum stool, which, when subject to the weight of a drummer and stool, shall neutralize any discernable forward momentum of the bass drum by the tendency of the greater mass of the inert drummer and stool subject to gravity and friction in its relative position to the ground to remain at rest which aids in the consistent and confidant playing of the bass drum

2. An apparatus consisting of an embodiment of claim 1 made of two durable and flexible straps that shall cradle the forward drum spurs in a pocket and connect in a “Y” configuration between the drum stool and the location of the drummers foot when placed on the drum pedal and then connect with the drum stool in a knot known commonly as a Girth Hitch.

3. An apparatus as described in claim 2 made of any material designed with the tensile strength and flexibility to maintain composition and usefulness under conditions implied in a use consistent with the circumstances described in claim 1.

4. An apparatus as described in claim 2 that connects to the drum stool by means of any sufficient securing method that maintains composition and usefulness under conditions implied in a use consistent with the circumstances described in claim 1.

5. An apparatus as described in claim 2 that has adjusters installed inline with the guy-straps made of any material designed with the tensile strength and functionality to maintain composition and usefulness under conditions implied in a use consistent with the circumstances described in claim 1.

6. An apparatus as described in claim 2 that has a side or center release buckle installed inline with the connection to the drum stool or seat and the “Y” configuration where the guy straps connect made of any material designed with the tensile strength and functionality to maintain composition and usefulness under conditions implied in a use consistent with the circumstances described in claim 1.
